(19) United States
(12) Patent Application Publication
(10) Pub. No.: US 2019/0200541 A1
(43) Pub. Date: Jul. 4, 2019

(54) APPARATUS FOR THE GROWING AND IRRIGATING OF PLANTS

(71) Applicant: Umbra LLC, Buffalo, NY (US)

(72) Inventor: Sung Wook Park, Toronto (CA)

(21) Appl. No.: 16/168,367

(22) Filed: Oct. 23, 2018

Related U.S. Application Data
(60) Provisional application No. 62/612,063, filed on Dec. 29, 2017.

(51) Int. Cl. A01G 9/24; A01G 9/02; A01G 9/04

(52) U.S. Cl. CPC A01G 9/247; A01G 9/042; A01G 9/02

(57) ABSTRACT

A plant growing apparatus, including a container, including a container bottom, a container wall, a container exterior surface, and a container interior surface, wherein the container wall is connected to the container bottom and extends upwardly therefrom, forming a container cavity therein, an insert arranged within the container, the insert including an insert bottom, an insert wall, an insert exterior surface, and an insert interior surface, wherein the insert wall is connected to the insert bottom and extends upwardly therefrom, forming an insert cavity therein, and a top, including a tray, a frame, and one or more first apertures, wherein the frame connects the tray to the container and the tray is supported by the frame above the container.

### CROSS-REFERENCE TO RELATED APPLICATIONS

This application claims the benefit under 35 U.S.C. § 119(e) of U.S. Provisional Application No. 62/612,063, filed on Dec. 29, 2017, which application is incorporated herein by reference in its entirety.

### FIELD

The present disclosure broadly relates to an apparatus for growing plants, and more specifically to an apparatus for the growing and irrigating of small household plants, such as herbs, vegetables, and flowers.

### BACKGROUND

Herb gardens have been used for many years to cultivate plants that are used as seasonings, fragrances, dyes, fibers, medicines, etc. In the medieval and Renaissance times nearly all plants were thought to have some medicinal value. In the early 20^{th} century, American gardeners founded the Herb Society of America to promote the knowledge and appreciation of herbs, and its members have since created and maintained many public and private herb gardens. However, more recently gardeners have become increasingly interested in the ornamental qualities of the herb garden. In the last few decades, herb garden plantings have greatly expanded as new color forms and types of herbs formerly grown solely for their usefulness have been developed.

As areas have become more populated over the last few centuries, the land on which to grow large herb gardens has become more limited. Space constraints, cost, and sheer convenience have forced some herb connoisseurs to move their gardens indoors. Heretofore, tradeoffs between flexibility in varieties, configurable arrangements, and cost were required. Additionally, in forming indoor herb gardens, some of the elements of nature are lost, such as natural watering through rainfall. Using such devices such as a watering can or pitcher can lead to erratic and unpredictable variability in the volume of water the various plants are receiving. Thus, there is a long-felt need for an apparatus for growing, housing, and irrigating plants that is compact, aesthetically pleasing, simulates the even distribution of natural rainfall when watering, and has a mechanism for easy disposal of excess water.

### SUMMARY

According to aspects illustrated herein, there is provided a plant growing apparatus, comprising a container, including a container bottom, a container wall, a container exterior surface, and a container interior surface, wherein the container wall is connected to the container bottom and extends upwardly therefrom, forming a container cavity therein, an insert arranged within the container, the insert including an insert bottom, an insert wall, an insert exterior surface, and an insert interior surface, wherein the insert wall is connected to the insert bottom and extends upwardly therefrom, forming an insert cavity therein, and a top, including a tray, a frame, and one or more first apertures, wherein the frame connects the tray to the container and the tray is supported by the frame above the container.

According to aspects illustrated herein, there is provided a plant growing apparatus, comprising a container, including a container bottom, a container wall, a container exterior surface, and a container interior surface, wherein the container wall is secured to the container bottom and extends upwardly therefrom, forming a container cavity therein, an insert nestedly arranged within the container, the insert comprising an insert bottom comprising one or more apertures, an insert wall, an insert exterior surface, and an insert interior surface, wherein the insert wall is secured to the insert bottom and extends upwardly therefrom, forming an insert cavity therein, and a top, including a tray comprising a tray bottom having a plurality of apertures, and a frame, wherein the frame connects the tray to the container, and the tray is supported by the frame above the container.

In an example embodiment, the insert bottom includes a plurality of apertures and the tray includes a tray bottom, where the tray bottom has a plurality of apertures that are equidistant from one another. Additionally, the frame includes two legs, each leg disposed on opposite ends of the container and the two legs are arranged perpendicular to the container. The tray and the container are disposed substantially parallel to one another. Moreover, the tray further includes a lip, where the lip is substantially perpendicular to the tray bottom. The insert further includes at least one flange and preferably two flanges, where each flange extends outwardly from the insert wall and is arranged substantially perpendicular to the insert wall. The two flanges are disposed opposite one another about the insert. The plant growing apparatus may be made of various materials, including plastic, metal, wood, rubber, polyvinyl chloride (PVC), etc., or any combination thereof. However, it should be appreciated that the plant growing apparatus can be made of any suitable material known in the art.

It is a general object of the present disclosure to provide an apparatus for growing and irrigating plants that is aesthetically pleasing while solving drawbacks of other known apparatuses, e.g., size limitations due to space constraints, loss of natural elements.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a front perspective view of a plant growing apparatus;

FIG. 2 is a front elevational view of the plant growing apparatus shown in FIG. 1, shown holding various herbs;

FIG. 3 is a front elevational view of the plant growing apparatus shown in FIG. 2, shown with the herbs removed;

FIG. 4 is a rear elevational view of the plant growing apparatus shown in FIG. 1;

FIG. 5 is a left side elevational view of the plant growing apparatus shown in FIG. 1;

FIG. 6 is a right side elevational view of the plant growing apparatus shown in FIG. 1;

FIG. 7 is a top plan view of the plant growing apparatus shown in FIG. 1;

FIG. 8 is a top plan view of the plant growing apparatus shown in FIG. 1; and,

FIG. 9 is an exploded view of the plant growing apparatus shown in FIG. 1.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments. The assembly of the present disclosure could be driven by hydraulics, electronics, pneumatics, and/or springs.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

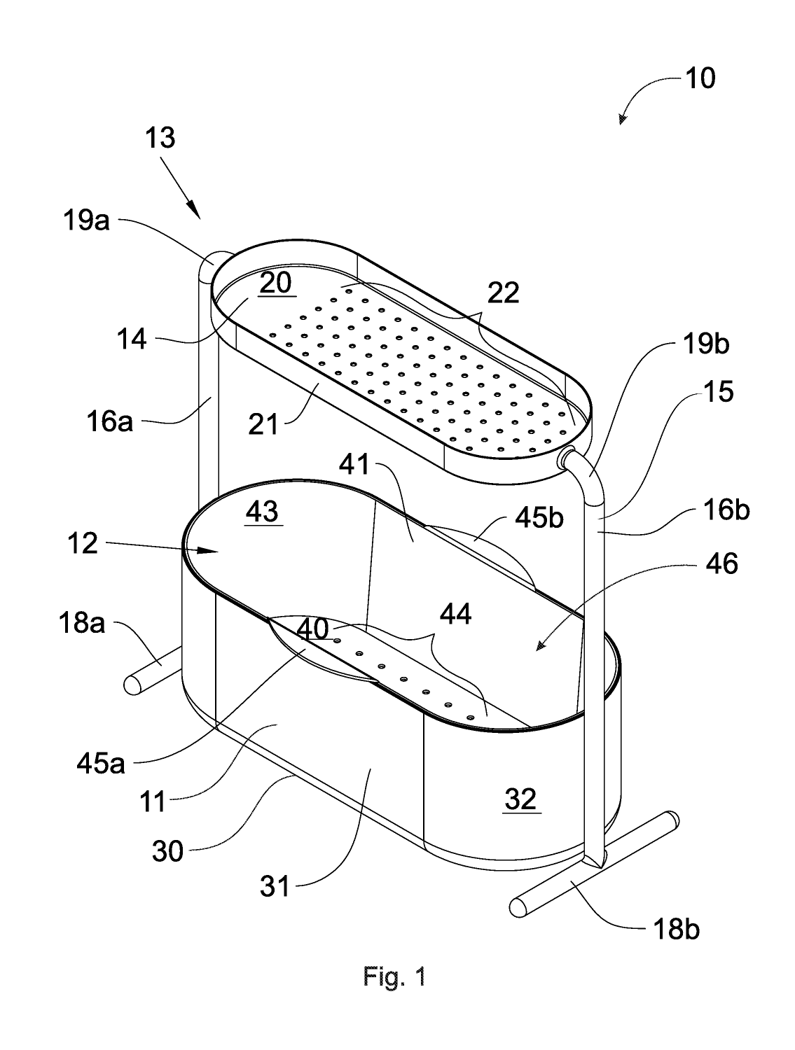

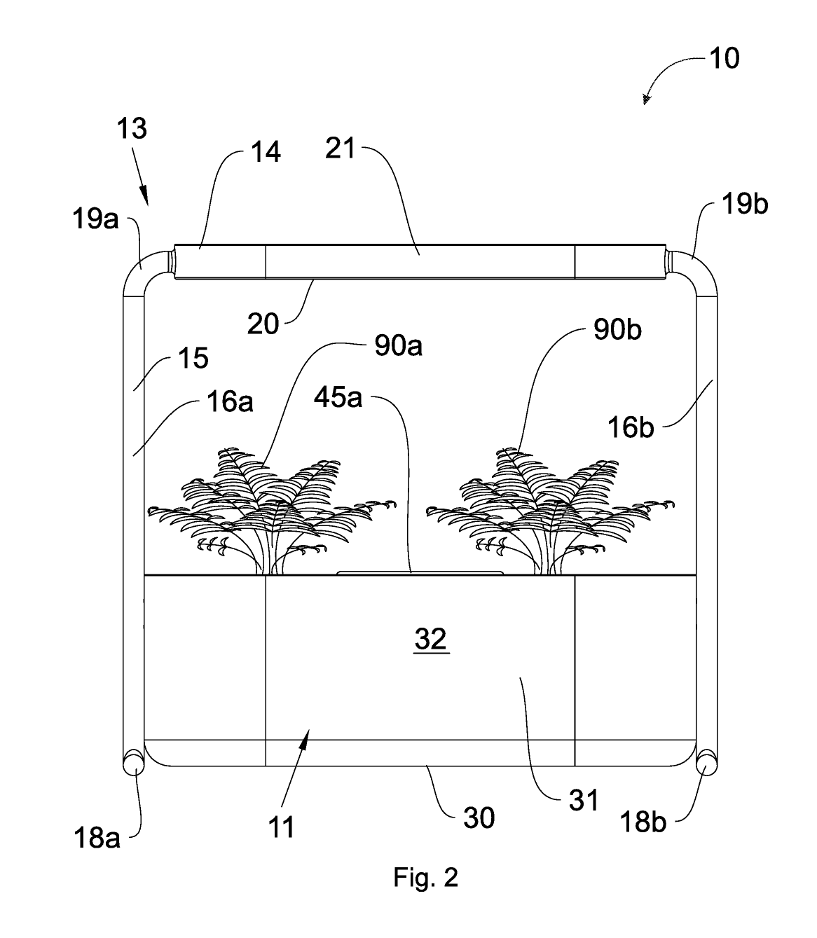

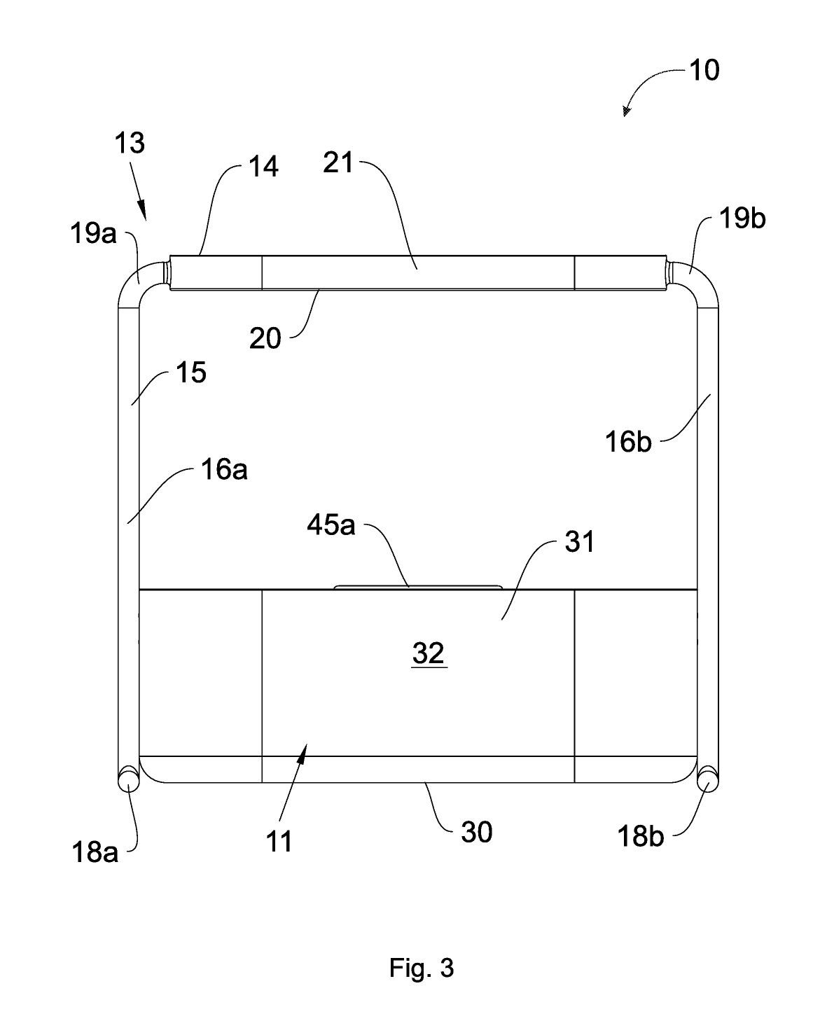

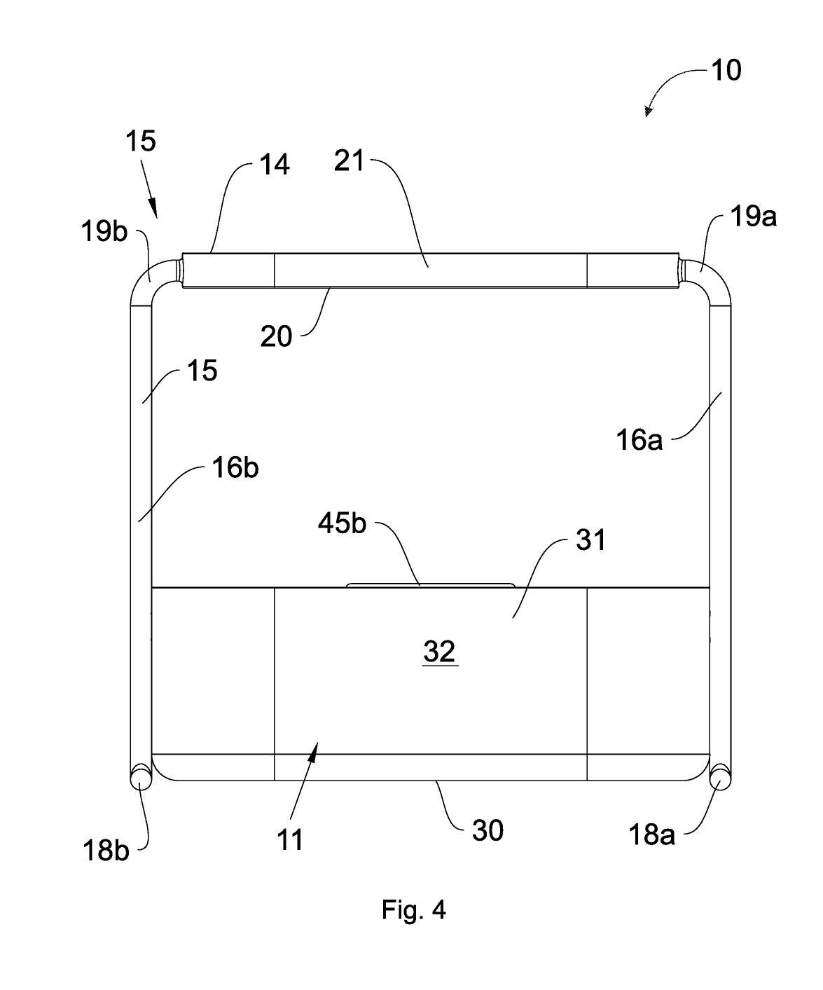

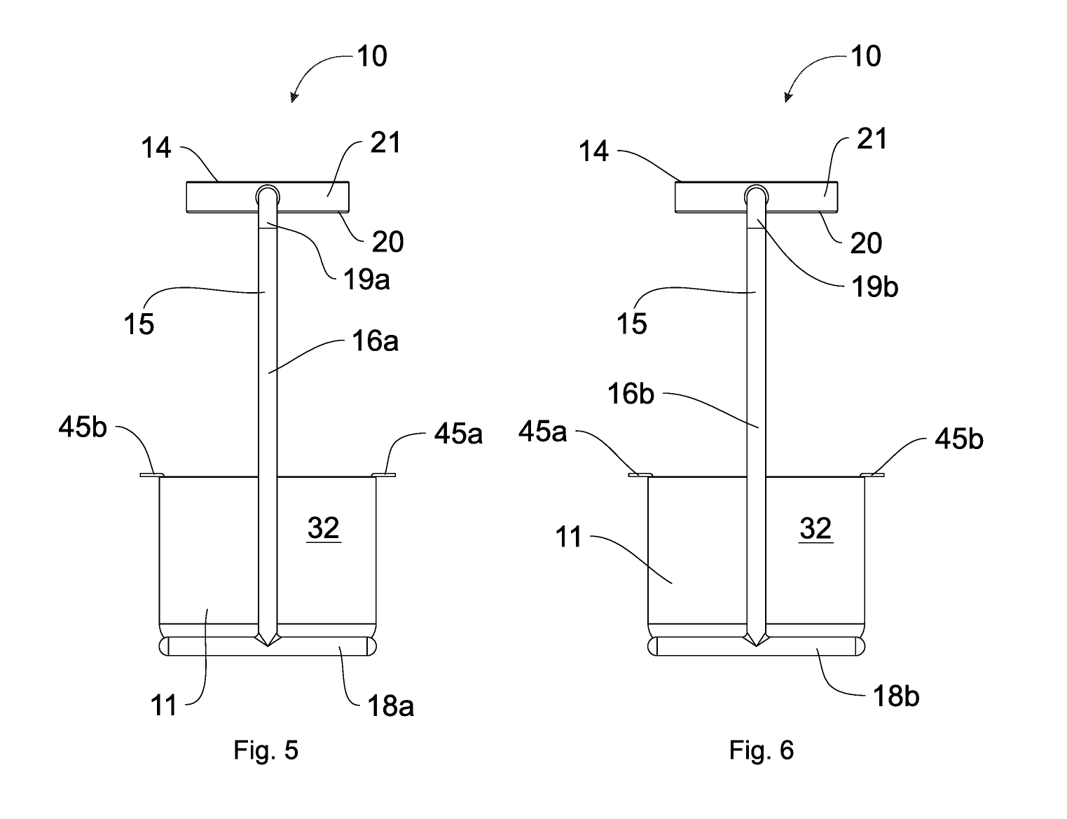

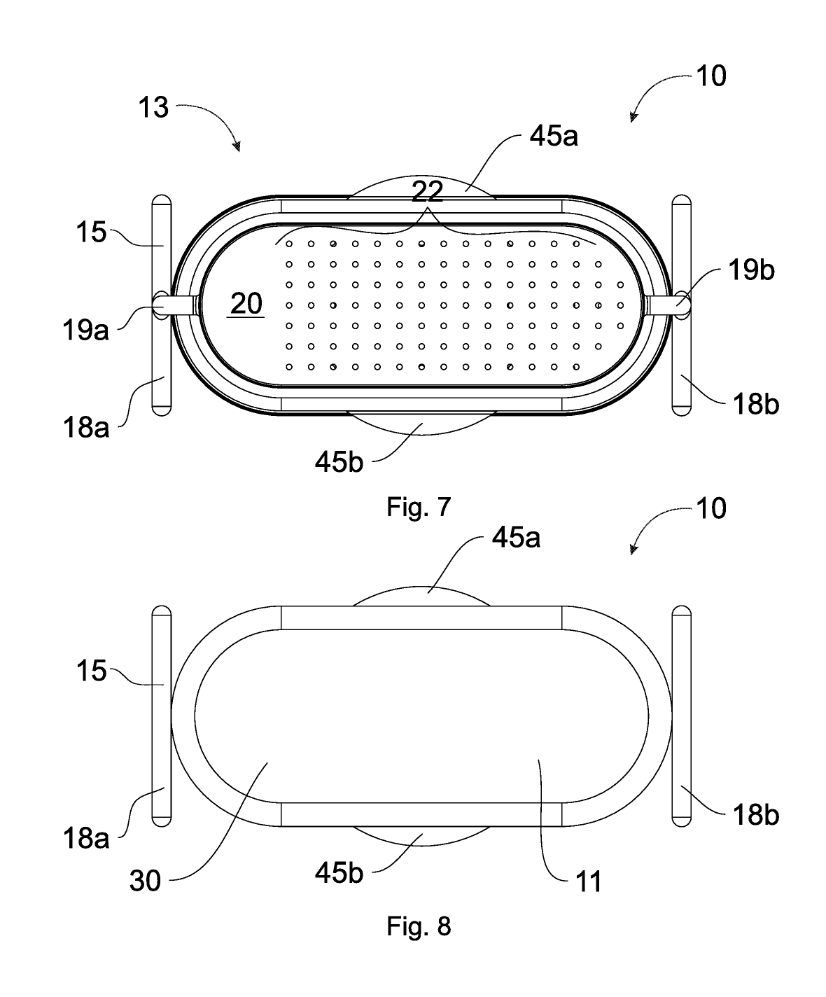

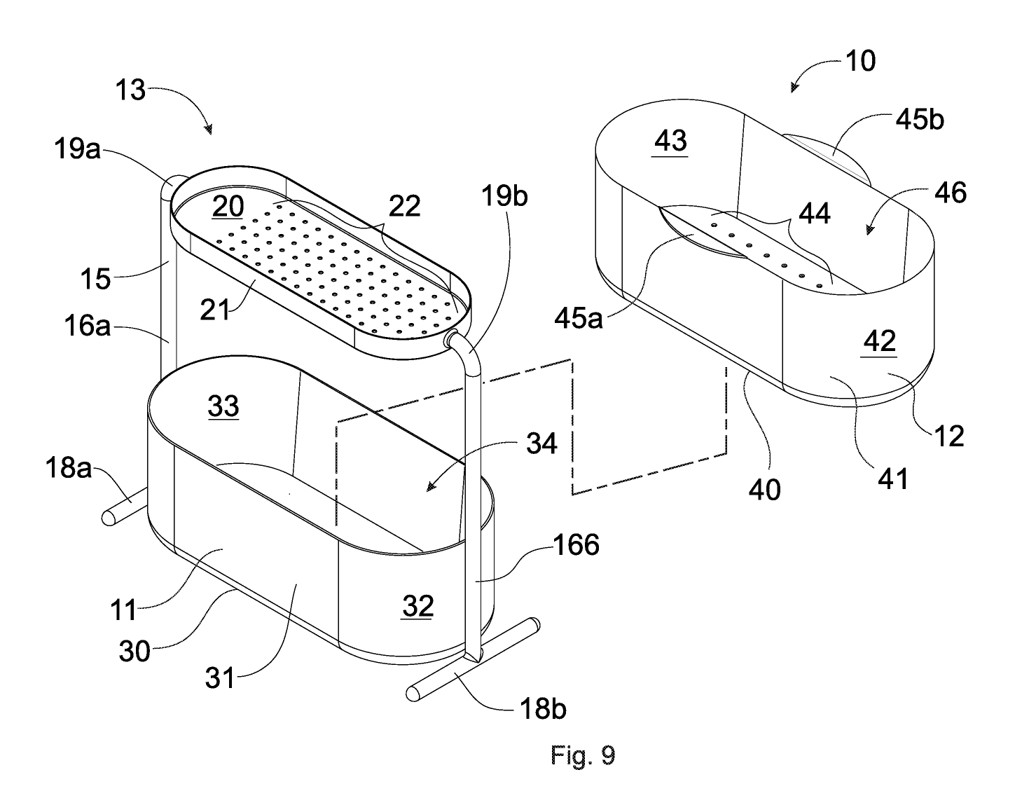

Adverting now to the figures, FIG. 1 shows a front perspective view of an example embodiment of plant growing apparatus 10. FIG. 2 is a front elevational view of plant growing apparatus 10, shown holding various herbs. FIG. 3 is a front elevational view of plant growing apparatus 10, shown with the herbs removed. FIG. 4 is a rear elevational view of plant growing apparatus 10. FIG. 5 is a left side elevational view of plant growing apparatus 10. FIG. 6 is a right side elevational view of plant growing apparatus 10. FIG. 7 is a top plan view of plant growing apparatus 10. FIG. 8 is a top plan view of plant growing apparatus 10. FIG. 9 is an exploded view of plant growing apparatus 10. The following description should be read in view of FIGS. 1 through 9.

As shown in the figures, plant growing apparatus 10 broadly includes container 11, insert 12, and top 13. Container 11 has container bottom 30, container wall 31, container exterior surface 32, and container interior surface 33. Container wall 31 is secured to container bottom 30 and extends upwardly therefrom, forming container cavity 34 therein. In an example embodiment, container 11 is substantially ovoid in shape; however, it should be appreciated that container 11 can be any suitable shape known in the art.

Insert 12 has insert bottom 40, insert wall 41, insert exterior surface 42, and insert interior surface 43. Insert 12 is nestedly arranged within container 11 and insert wall 41 is secured to insert bottom 40 and extends upwardly therefrom, forming insert cavity 46 therein. In an embodiment, insert bottom 40 includes one or more apertures 44, wherein the one or more apertures 44 are spaced equidistant from one another to allow for the even flow of the drainage of water. In an example embodiment, apertures 44 are not equidistant from each other. Insert 12 further includes at least one flange and preferably two flanges 45a and 45b. Each flange 45a, 45b extends outwardly from insert wall 41 and is arranged substantially perpendicular to insert wall 41. In an example embodiment, flanges 45a, 45b are disposed opposite one another about insert wall 41. When insert 12 is arranged within container 11, insert exterior surface 42 abuts against, or is arranged substantially proximate to, container interior surface 33. Similarly, when insert 12 is arranged within container 11, insert bottom 40 abuts against, or is arranged substantially proximate to, container bottom 30. It should be appreciated that insert 12 is removably arranged within container 11.

Preferably, insert 12 is filled with a plant growing medium, such as soil, which is disposed within insert cavity 46, to support the growing of plants, such as herbs 90a, 90b, as shown in FIG. 2, and a fluid medium, such as water, is used to irrigate the plants. Flanges 45a, 45b are used by an individual to lift insert 12 out of container 11 in order for the excess water to drain from insert 12 and to subsequently replace insert 12. The excess water that has collected in the adjacent container, i.e., container 12, can then be easily disposed of. In an example embodiment, insert 12 is substantially ovoid in shape; however, it should be appreciated that insert 12 can be any suitable shape known in the art. Preferably, container 11 and insert 12 comprise the same or substantially similar geometry, such that when insert 12 is nestedly arranged within container 11, insert 12 fits tightly therein, leaving no space between insert exterior surface 42 and container interior surface 33. In an example embodiment, when insert 12 is nestedly arranged within container 11, a space is formed between insert exterior surface 42 and container interior surface 33. Having such a space may be beneficial in allowing excess water to drain from insert 12 into the container 11. In an example embodiment, flanges 45a, 45b allow insert 12 to rest atop the container wall 31.

Top 13 has tray 14, frame 15, and one or more apertures 22, wherein frame 15 connects tray 14 to container 11 and tray 14 is supported by frame 15 above container 11. In an example embodiment, top 13 comprises a plurality of apertures (as shown in the figures) to allow for even watering as water passes through tray bottom 20 to insert 12. In an example embodiment, frame 14 includes two legs 16a, 16b, each leg having base 18a, 18b, and elbow 19a, 19b respectively. Legs 16a, 16b are disposed on opposite ends and each secured to container 11 and legs 16a, 16b are arranged perpendicular to container 11. In particular, elbow 19a is disposed opposite base 18a about leg 16a and elbow 19b is disposed opposite base 18b about leg 16b. Base 18a extends outwardly from and perpendicular to leg 16a and base 18b extends outwardly from and perpendicular to leg 16b. Bases 18a, 18b support legs 16a, 16b, respectively, as bases 18a, 18b rest upon a surface. Elbows 19a, 19b extend from legs 16a, 16b, respectively, at approximately 90 degree angles. Elbows 19a, 19b are disposed opposite one another about tray 14 and secure legs 16a, 16b, respectively, to tray 14. It should be appreciated that in an example embodiment, bases 18a, 18b can be integral with legs 16a, 16b, and similarly elbows 19a, 19b can be integral with legs 16a, 16b. Moreover, tray 14 can be integral with or secured via an attachment means to elbows 19a, 19b. Any element described herewith that can be secured to a secondary element may also be integral with the secondary element as an alternative. Furthermore, it should be appreciated that any attachment means known to one skilled in the art can be used to secure one element to another, such as screws, adhesive, bolts, rivets, welding, etc.

Tray 14 includes tray bottom 20 and lip 21. Tray bottom 20 comprises one or more apertures 22. In an example embodiment, one or more apertures 22 are disposed equidistant from one another. In an example embodiment, one or more of apertures 22 are not arranged equidistant from one another. In an example embodiment, tray 14 and container 11 are disposed substantially parallel to one another. In an example embodiment, tray 14 is arranged non-parallel to container 11. Lip 21 extends upwardly from tray bottom 20 and lip 21 is arranged substantially perpendicular to tray bottom 20. Frame 15 supports tray 14 in a position above herbs 90a, 90b, as well as above insert 12 and container 11. As a fluid medium, such as water, is poured from a watering device, such as a watering can, pitcher, etc., the water collects in tray 14 and flows through apertures 22 into insert 12 and onto the plants, providing an even distribution of water similar to natural rainfall.

Plant growing apparatus 10 and its various elements may comprise a variety of materials, including plastic, metal, wood, rubber, polyvinyl chloride (PVC), etc., or any combination thereof. However, it should be appreciated that plant growing apparatus 10 can be made of any suitable material known in the art.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### LIST OF REFERENCE NUMERALS

10 Plant growing apparatus
11 Container
12 Insert
13 Top
14 Tray
15 Frame
16a Leg
16b Leg
18a Base
18b Base
19a Elbow
19b Elbow
20 Tray bottom
21 Lip
22 Apertures
30 Container bottom
31 Container wall
32 Container exterior surface
33 Container interior surface
34 Container cavity
40 Insert bottom
41 Insert wall
42 Insert exterior surface
43 Insert interior surface
44 Apertures
45a Flange
45b Flange
46 Insert cavity
90a Herb
90b Herb

What is claimed is:

1. A plant growing apparatus, comprising:
a container, including:
a container bottom;
a container wall;
a container exterior surface; and,
a container interior surface, wherein the container wall is connected to the container bottom and extends upwardly therefrom, forming a container cavity therein;
an insert arranged within the container, the insert including:
an insert bottom;
an insert wall;
an insert exterior surface; and,
an insert interior surface, wherein the insert wall is connected to the insert bottom and extends upwardly therefrom, forming an insert cavity therein; and,
a top, including:
a tray;
a frame; and,
one or more first apertures, wherein the frame connects the tray to the container and the tray is supported by the frame above the container.

2. The plant growing apparatus as recited in claim 1, wherein the insert includes one or more second apertures.

3. The plant growing apparatus of claim 2, wherein the one or more second apertures are arranged in the insert bottom.

4. The plant growing apparatus of claim 1, wherein the tray comprises a tray bottom and the one or more first apertures are disposed in the tray bottom.

5. The plant growing apparatus of claim 4, wherein the one or more first apertures is arranged equidistant from one another.

6. The plant growing apparatus of claim 1, wherein the frame comprises at least one leg.

7. The plant growing apparatus of claim 6, wherein the at least one leg is arranged perpendicular to the container bottom.

8. The plant growing apparatus of claim 6, wherein the frame comprises two legs disposed on opposite ends of the container.

9. The plant growing apparatus of claim 1, wherein the tray and the container are disposed substantially parallel to one another.

10. The plant growing apparatus of claim 4, wherein the tray further comprises a lip, the lip being substantially perpendicular to the tray bottom.

11. The plant growing apparatus of claim 1, wherein the insert further comprises at least one flange, the at least one flange extending outwardly from the insert wall.

12. The plant growing apparatus of claim 11, wherein the insert comprises two flanges.

13. A plant growing apparatus, comprising:
a container, including:
a container bottom;
a container wall;
a container exterior surface; and,
a container interior surface, wherein the container wall is secured to the container bottom and extends upwardly therefrom, forming a container cavity therein;
an insert nestedly arranged within the container, the insert comprising:
an insert bottom comprising one or more apertures;
an insert wall;
an insert exterior surface; and,
an insert interior surface, wherein the insert wall is secured to the insert bottom and extends upwardly therefrom, forming an insert cavity therein; and,
a top, including:
a tray comprising a tray bottom having a plurality of apertures; and,
a frame, wherein:
the frame connects the tray to the container; and,
the tray is supported by the frame above the container.

14. The plant growing apparatus of claim 13, wherein the plurality of apertures are disposed equidistant to one another.

15. The plant growing apparatus of claim 13, wherein the frame comprises at least one leg.

16. The plant growing apparatus of claim 15, wherein the at least one leg is arranged perpendicular to the container bottom.

17. The plant growing apparatus of claim 15, wherein the frame comprises two legs disposed on opposite ends of the container.

18. The plant growing apparatus of claim 13, wherein the tray further comprises a lip connected to, and extending from, the tray bottom.

19. The plant growing apparatus of claim 13, wherein the insert further comprises at least one flange, the at least one flange extending outwardly from the insert wall.

20. The plant growing apparatus of claim 19, wherein the at least one flange is arranged to overlap the container wall.
